(19) United States
(12) Patent Application Publication
(10) Pub. No.: US 2024/0201417 A1
(43) Pub. Date: Jun. 20, 2024

(54) SYSTEM FOR BUILDING MACHINE LEARNING MODELS TO ACCELERATE SUBSURFACE MODEL CALIBRATION

(71) Applicant: Schlumberger Technology Corporation, Sugar Land, TX (US)

(72) Inventors: Mohamed Osman Mahgoub Ahmed, Abu Dhabi (AE); Taoufik Manai, Clamart (FR); Sanjoy Khataniar, Abingdon (GB); Shripad Biniwale, Abu Dhabi (AE)

(21) Appl. No.: 18/470,080

(22) Filed: Sep. 19, 2023

Related U.S. Application Data
(60) Provisional application No. 63/376,135, filed on Sep. 19, 2022.

(51) Int. Cl. G01V 20/00; E21B 44/00

(52) U.S. Cl. CPC G01V 20/00; E21B 44/00; E21B 2200/20; E21B 2200/22

(57) ABSTRACT

A method for calibrating a reservoir model includes receiving a reservoir model of a reservoir. The method also includes simulating ensembles of dynamic cases of the reservoir model to produce simulated dynamic cases. Each dynamic case is different. The dynamic cases each include a plurality of levels. The method also includes performing history matching between the simulated dynamic cases and observed production data to identify a combination of parameters of the reservoir model or values of the parameters. The combination of parameters or values of the parameters result in one or more mismatch values between the simulated dynamic cases and the observed production data being less than a mismatch threshold. The method also includes generating a display based upon the combination of the parameters or the values of the parameters that result in the one or more mismatch values being less than the mismatch threshold.

### CROSS-REFERENCE TO RELATED APPLICATIONS

This application claims priority to U.S. Provisional Patent Application No. 63/376,135, filed on Sep. 19, 2022, the entirety of which is incorporated by reference.

### BACKGROUND

Simulation models receive a considerable amount of reservoir data. The simulation models can be used in the decision-making process to enhance field performance. The ability to search the options and evaluate different control scenarios may improve infill well placement, well count determination, waterfloods, and enhanced oil recovery. However, the likelihood of a model capturing the real reservoir performance is related to how close its output matches historical production data. Hence, history-matching is used to ensure the relevance of the asset subsurface numerical models.

Reservoir engineers can spend months searching for input values such that the output agrees with the general observations of the field. Delaying history-matching results means delaying the enhancement process that helps ensure efficient use of hydrocarbon assets.

### SUMMARY

A method for calibrating a reservoir model is disclosed. The method includes receiving a reservoir model of a reservoir. The method also includes simulating ensembles of dynamic cases of the reservoir model to produce simulated dynamic cases. Each dynamic case is different. The dynamic cases each include a plurality of levels. The method also includes performing history matching between the simulated dynamic cases and observed production data to identify a combination of parameters of the reservoir model or values of the parameters. The combination of parameters or values of the parameters result in one or more mismatch values between the simulated dynamic cases and the observed production data being less than a mismatch threshold. The method also includes generating a display based upon the combination of the parameters or the values of the parameters that result in the one or more mismatch values being less than the mismatch threshold.

A computing system is also disclosed. The computing system includes one or more processors and a memory system. The memory system includes one or more non-transitory computer-readable media storing instructions that, when executed by at least one of the one or more processors, cause the computing system to perform operations. The operations include receiving a reservoir model of a reservoir. The reservoir model includes a static model, a dynamic model, or both. The reservoir model includes uncertainty framing inputs that define types and ranges of parameters in the reservoir model that are uncertain. The operations also include simulating ensembles of dynamic cases of the reservoir model to produce simulated dynamic cases. Each dynamic case is different. The dynamic cases each include a plurality of different levels. The levels include a global level, a regional level, a well level, and a completion level. The dynamic cases are simulated by varying values of the parameters on each level, by varying the values of the parameters on the different levels, or both. The operations also include performing assisted history matching between the simulated dynamic cases and observed production data to identify a combination of the parameters and the values of the parameters. The combination of the parameters and the values of the parameters result in one or more mismatch values between the simulated dynamic cases and the observed production data being less than a mismatch threshold. The assisted history matching is performed using proxy modeling or ensemble Kalman filters. The operations also include generating a display based upon the combination of the parameters or the values of the parameters that result in the one or more mismatch values being less than the mismatch threshold. The display includes a plurality of dashboard components that expedite subsequent iterations of the assisted history matching.

A non-transitory computer-readable medium is also disclosed. The medium stores instructions that, when executed by one or more processors of a computing system, cause the computing system to perform operations. The operations include receiving a reservoir model of a reservoir that includes a static model and a dynamic model. The reservoir model includes uncertainty framing inputs that define types and ranges of parameters in the reservoir model that are uncertain. The parameters include porosity, permeability, compressibility, and relative permeability. The operations also include simulating ensembles of dynamic cases of the reservoir model to produce simulated dynamic cases. Each dynamic case is different. The dynamic cases each include a plurality of different levels. The levels include a global level, a regional level, a well level, and a completion level. The dynamic cases are simulated by varying values of the parameters on each level such that a first of the parameters has a first value in a first of the dynamic cases on a first of the levels, and the first parameter has a second value in a second of the dynamic cases on the first level. Th first and second values are different. The dynamic cases are also simulated by varying the values of the parameters on the different levels such that the first parameter has a third value in a third of the dynamic cases on the first level, and the first parameter has a fourth value in a fourth of the dynamic cases on a second one of the levels. The third and fourth values are different. The operations also include performing assisted history matching between the simulated dynamic cases and observed production data to identify a combination of the parameters and the values of the parameters. The combination of the parameters and the values of the parameters result in one or more mismatch values between the simulated dynamic cases and the observed production data being less than a mismatch threshold. The assisted history matching is performed using proxy modeling or ensemble Kalman filters. The operations also include generating a display based upon the combination of the parameters or the values of the parameters that result in the one or more mismatch values being less than the mismatch threshold. The display includes a plurality of dashboard components that expedite subsequent iterations of the assisted history matching. The operations also include performing a wellsite action in response to the one or more mismatch values, the combination of the parameters or the values of the parameters, or the dashboard components. The wellsite action includes generating or transmitting a signal that causes a physical action to occur at a wellsite.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A-1D illustrate an example of a system that includes various management components to manage various aspects of a geologic environment, according to an embodiment.

FIGS. 2A and 2B illustrate an ensemble coverage metric based on ensemble results compared with the observed data for two wells: one with a poor ensemble coverage 17% (FIG. 2A) and another with a good ensemble coverage 97% (FIG. 2B), according to an embodiment.

FIG. 3 illustrates a map created based on ensemble coverage statistics to highlight regional trends, according to an embodiment.

FIG. 4 illustrates a response surface generated based on the objective function of a reservoir model, according to an embodiment.

FIGS. 5A-5D illustrate history-matching parameter distributions, according to an embodiment.

FIG. 6A illustrates a flowchart of a method for deploying ML proxies, and FIG. 6B illustrates history-matching results of a field, according to an embodiment.

FIG. 7 illustrates a flowchart of a method for expediting dynamic model calibration using machine-learning (ML) and cloud high performance computing (HPC), according to an embodiment.

FIG. 8 illustrates a schematic view of a cloud system for ML that performs assisted history matching, according to an embodiment.

FIG. 9 illustrates a schematic view of ML history matching solution workflow steps, according to an embodiment.

FIG. 10 illustrates an ensemble Kalman filters post-processing workflow, according to an embodiment.

FIGS. 11-11G illustrate displays (e.g., graphs) showing an ensemble coverage analysis, according to an embodiment.

FIGS. 12A-12D illustrate displays (e.g., graphs) showing a mismatch analysis on 2D plots (at the field level), according to an embodiment.

FIGS. 13A-13G illustrate displays (e.g., graphs) showing a mismatch analysis on 2D plots (at the well level), according to an embodiment.

FIG. 14 illustrates an ensemble level dynamic grid properties analysis, according to an embodiment.

FIGS. 15A-15D illustrate displays (e.g., graphs) showing a performance dashboard (e.g., time-step selection analysis), according to an embodiment.

FIGS. 16A-16D illustrate displays (e.g., graphs) showing a performance dashboard (e.g., field level profiles collected from log files), according to an embodiment.

FIG. 17 illustrates a performance dashboard (e.g., filterable detailed convergence reports), according to an embodiment.

FIG. 18 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

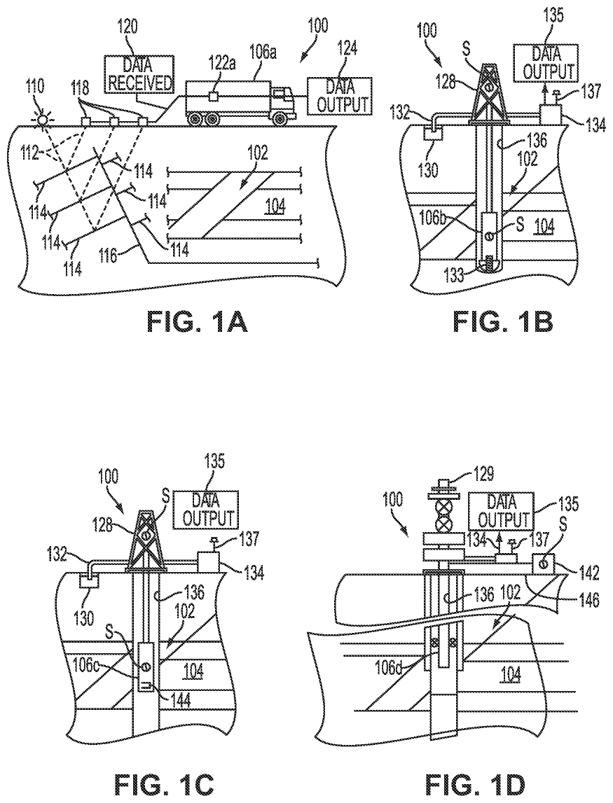

FIGS. 1A-1D illustrate an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIGS. 1A-ID, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT®.NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIGS. 1A-ID, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIGS. 1A-1D, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIGS. 1A-1D also show an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIGS. 1A-1D, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIGS. 1A-ID, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIGS. 1A-1D, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIGS. 1A-1D show a satellite in communication with the network 155 that may be configured for communications, noting that the satellite may additionally or instead include circuitry for imagery (e.g., spatial, spectral, temporal, radiometric, etc.).

FIGS. 1A-1D also show the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

### System for Building Machine Learning Models to Accelerate Subsurface Model Calibration

Embodiments of the disclosure include a workflow for parameterization using Python scripts within an oilfield simulator, such as the INTERSECT® simulator, ECLIPSE® simulator, etc. This may allow a user to increase the number of history-matching parameters (e.g., to hundreds or more), which in turn, may accelerate the readiness of models for the decision-making process (e.g., where to drill, how to steer, etc.) by expediting the history-matching process. A reservoir engineer may be employed to obtain reservoir engineering data. Simulation output files (e.g., 2D and 3D) may be used to populate simulation results data tables for mismatch calculation and for decision dashboards. Depth nodes of repeated formation tester (RFT) and/or production log tool (PLT) data from a simulation and actual measured data may not be aligned. In some embodiments, a method disclosed herein may be implemented to calculate their mismatch.

In some embodiments, the method begins by framing the reservoir uncertainty through understanding the static and dynamic model-building workflows. At this stage, uncertainties may be evaluated, to decide on value ranges for them, based on available information. Early reservoir model ensembles may not fully bracket the observed behavior of the field. Ensemble coverage analysis may facilitate quickly deciding on adding parameters and/or altering the uncertainty range for existing parameters.

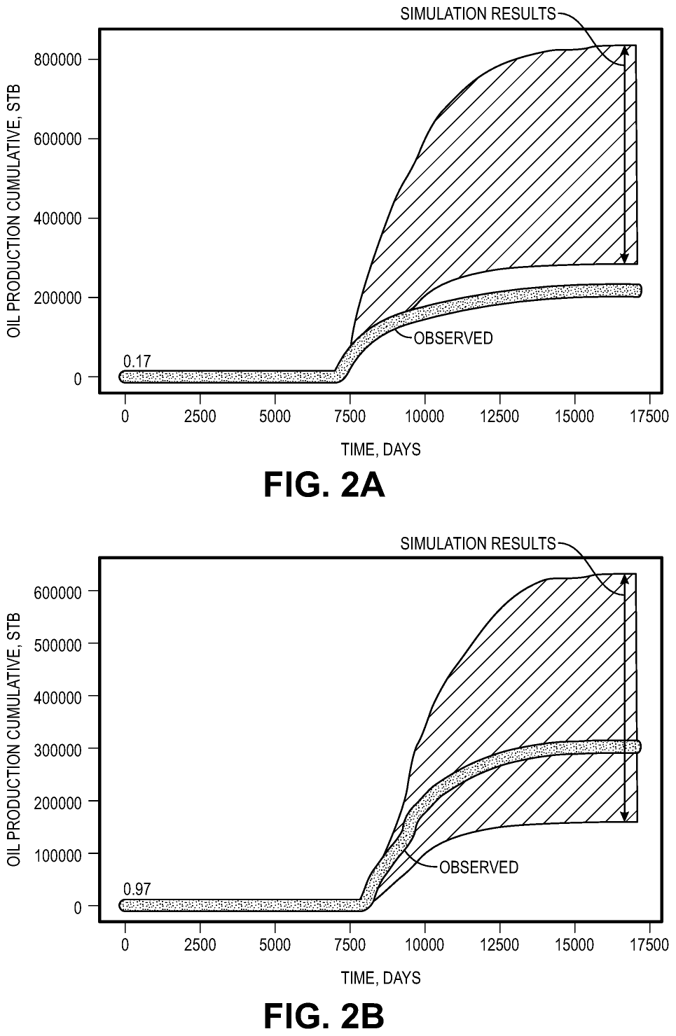

FIGS. 2A and 2B illustrate an ensemble coverage metric based on ensemble results compared with observed data for two wells, according to an embodiment. More particularly, FIG. 2A shows an ensemble coverage of 17%, and FIG. 2B shows an ensemble coverage of 97%.

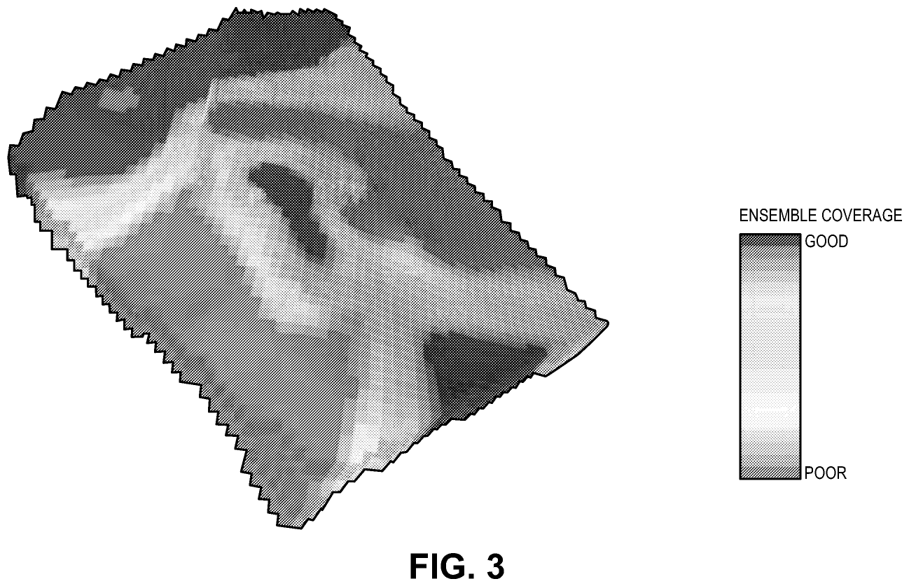

FIG. 3 illustrates a map created based on ensemble coverage statistics to highlight regional trends. Additional parameters and/or value range changes may be targeted in regions where the ensemble coverage is relatively poor.

After ensuring coverage of uncertainty and field profiles, several simulation ensembles may be generated and run. The number of simulation cases per ensemble may vary (e.g., hundreds) depending on the number of history-matching parameters and hardware availability. The simulation input and output data from these ensembles are collected in structured datasets. A distance measure between simulation results and observed data may be agreed upon and used to calculate the objective function, which is the target variable for the machine learning model. The history-matching parameters may be analyzed and scaled to be used as input features before ML training.

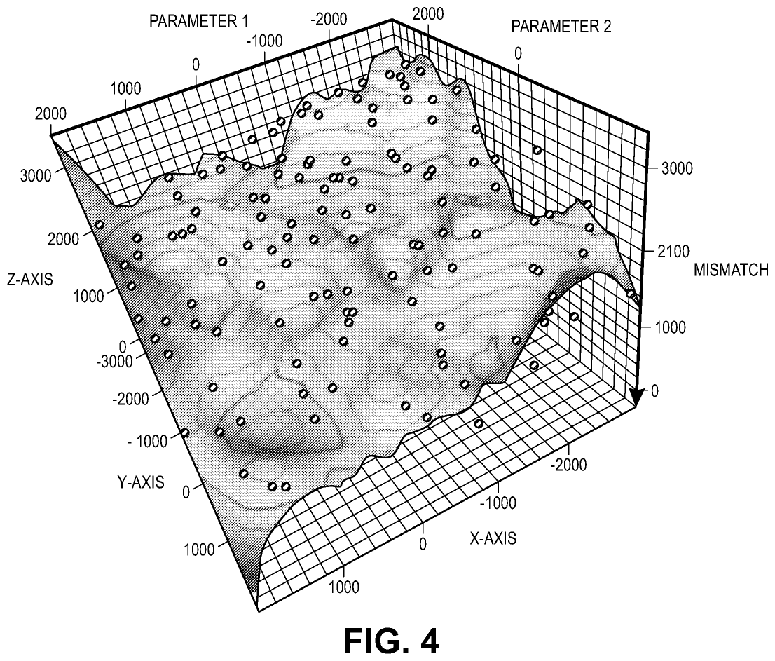

The ML training is performed to discover the relationship between the history-matching parameters and the objective function. Linear and polynomial relationships may be used in proxy modeling but may not capture the complexity of some simulation models. In contrast, ML methods are well-suited to capture this complexity based on their 100s and 1000s degrees of freedom, as shown in FIG. 4, which shows a response surface generated based on the objective function of a reservoir model. There are several combinations of parameters 1 and 2 that can lead to a small mismatch value.

The ML models may be built based on the field, regional, or well levels to achieve history-matching. For regional and well levels, pre-processing may be conducted and followed to select the relevant history-matching parameters for each entity (e.g., region or well).

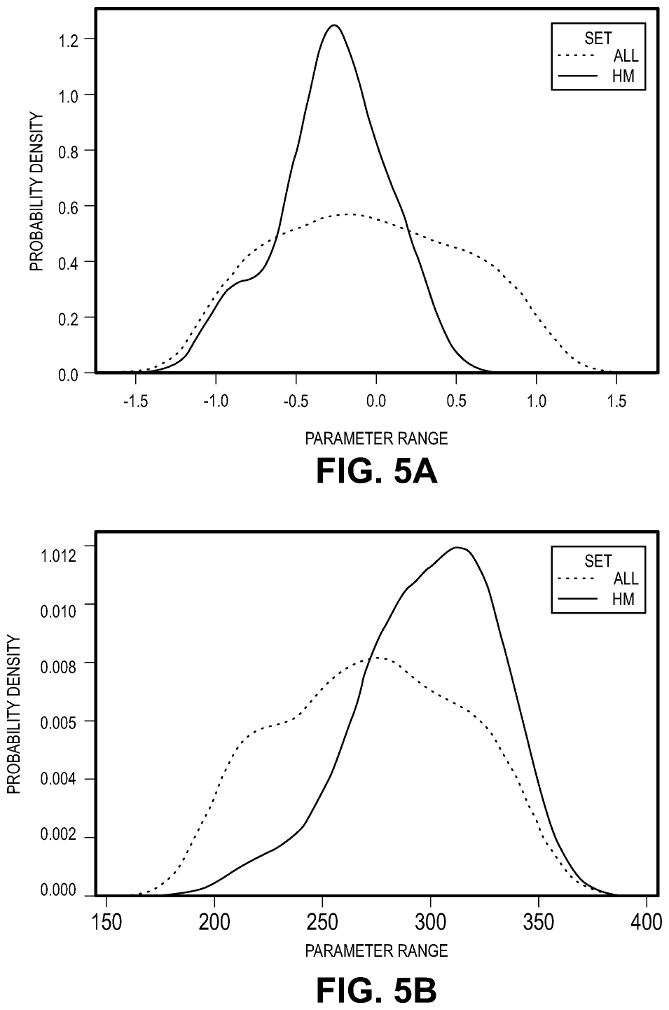

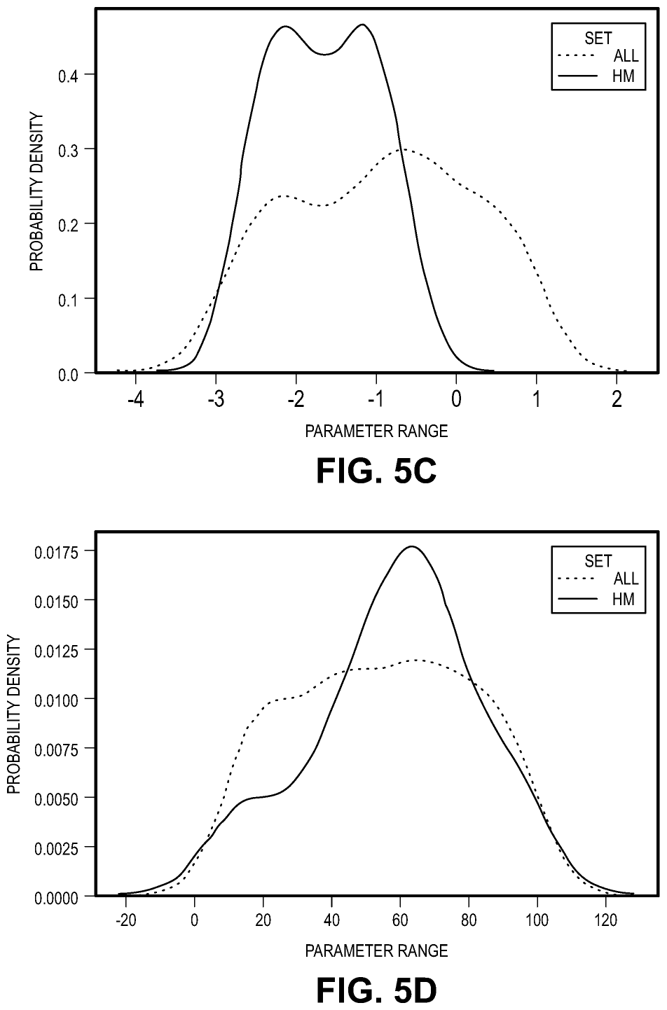

The combined dataset of history-matching parameters and the calculated objective function can be analyzed for clear history-matching trends. This can assist in refining the parameter space range and sampling methods before submitting secondary and tertiary ensembles for further refinement of the history-matching process. FIGS. 5A-5D illustrate graphs showing the distribution of several history-matching parameters before and after filtering based on the mismatch value. The dashed curves represent all ensemble runs, and the solid curves represent a subset of the cases where the mismatch is acceptable (e.g., greater than a mismatch threshold). The concentration of acceptable probability density function values provides indications of subsequent parameter values that can reduce the difference between simulation results and observed data.

### Deploying the ML Proxies

Once the ML proxies are validated, the ML proxies may be deployed to quickly to find areas in the parameter space where the mismatch value is less than a threshold. In an embodiment, the threshold may be predetermined (e.g., by a user and/or by the computing system), and the threshold may be fixed or adjustable. This can be achieved through a grid search method to explore the parameter space. The ML proxies may then be evaluated at one, some, or every combination of parameters, and values of the mismatch below the threshold may be recorded with their corresponding input features. The recorded parameter combinations can then be analyzed separately following the same methodology. The output from the grid search process may be a set of recommended history-matching parameter values that can be verified through confirmatory simulation runs.

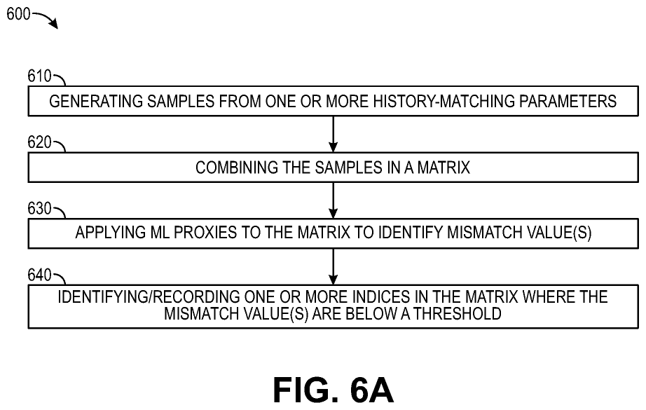

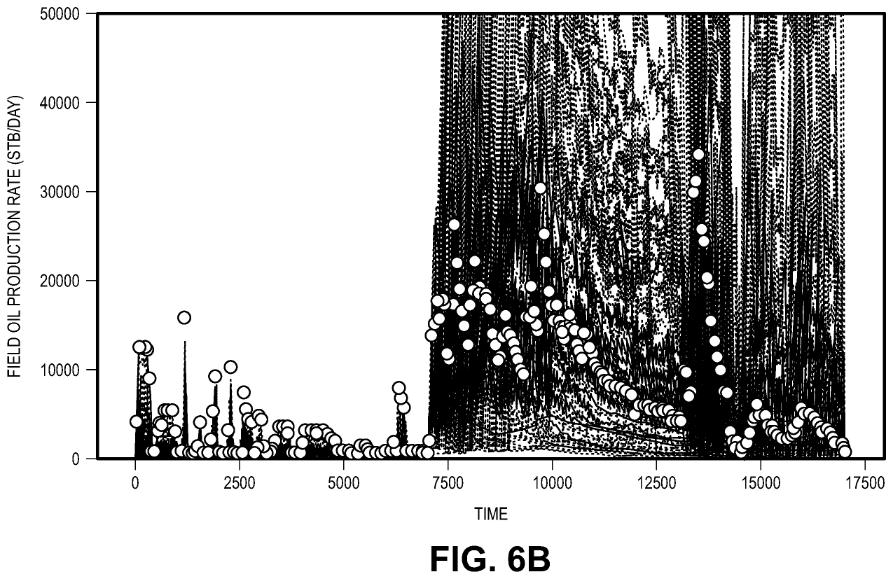

FIG. 6A illustrates a flowchart of a method 600 for deploying the ML proxies, according to an embodiment. The method 600 may include generating samples from each history-matching parameter, as at 610. The samples may be generated by random selection from the parameters' prior distributions, or with equal spacing knowing the minimum and maximum values of the parameters.

The method 600 may also include combining the samples in a matrix, as at 620. The matrix may be or include a full factorial matrix.

The method 600 may also include applying the ML proxies to the matrix to identify mismatch value(s), as at 630.

The method 600 may also include identifying/recording one or more indices in the matrix where the ML-predicted mismatch value(s) are below the threshold, as at 640.

This method 600 may be iterative. Thus, portions of the method 600 may be repeated after narrowing the sample search around the values of the recorded indices. Additional optimization methods can be applied to the ML proxies with a mismatch minimization objective. Examples of additional optimization methods may include the Powell optimizer or the Particle Swarm Optimization method.

### Results

The history-matching results may be refined through successive ensemble runs during which parameter sampling methods and ranges may be perturbed in addition to the definition of new local and global parameters. The process is designed to define the parameter spaces at which the mismatch value is less than the threshold, if they can be found from the simulation ensemble data. The ability of ML proxies to correctly represent the reservoir behavior may depend on the accuracy of the simulation models used to create them.

Several parameter combinations may exist that equally result in mismatch values below the threshold. In such cases, a suite of models can be defined as a history-matched ensemble, enabling probability-based assessment of reservoir deliverability. FIG. 6B illustrates a graph showing history-matching results at the field level with multiple simulation cases matching the field production profiles. The dots and/or the darker regions of the graph represent better mismatch values (e.g., above the threshold).

### Simulation Dashboards

Visualization of simulation data provides insights that can equal the benefits of ML proxies in achieving history-matching. There are different types of simulation input and output data: summary vectors showing field profiles at different levels (e.g., completions, wells, groups, and field), depth and time-based pressure and flow profiles (e.g., repeat formation tester (RFT) and/or production logging tool (PLT) data), static and dynamic grid properties (e.g., porosity, permeability trends, pressure, and fluid saturations). These can be merged with history-matching parameter distributions and/or mismatch values to create dashboards that can be helpful during history-matching and for analyzing ensemble-level results.

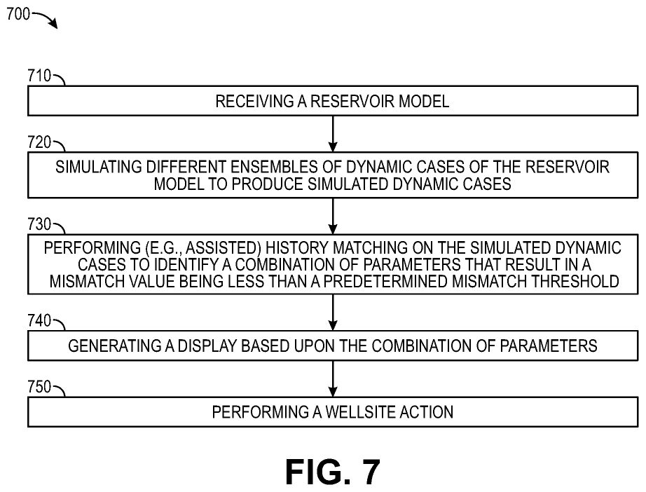

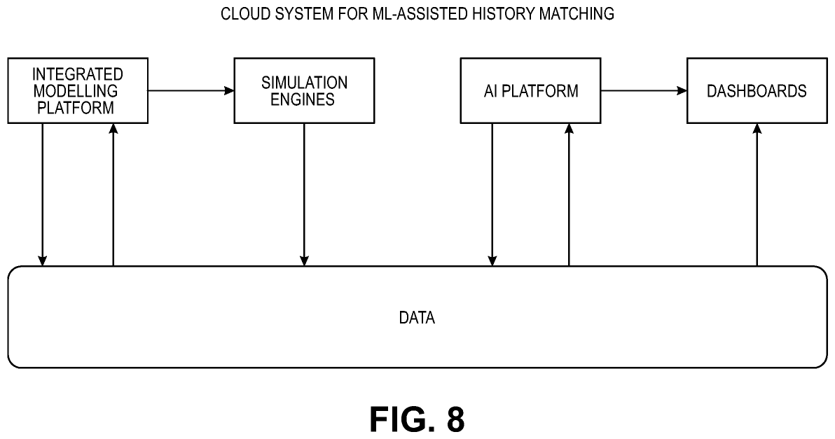

FIG. 7 illustrates a flowchart of a method 700 for calibrating one or more dynamic models of a subsurface (e.g., reservoir), according to an embodiment. More particularly, the method 700 may expedite dynamic model calibration using ML and/or HPC cloud technologies. An illustrative order of the method 700 is provided below; however, one or more portions of the method 700 may be performed in a different order, simultaneously, repeated, or omitted. FIG. 8 illustrates a schematic view of the method 700 shown in FIG. 7.

The method 700 may include receiving a reservoir model, as at 710. The reservoir model may be or include a static reservoir model and/or a dynamic reservoir model. A static model includes a structural framework of a subsurface reservoir (e.g., faults, folds) and a geometrical grid hosting petrophysical parameter variation (e.g., rock porosity, permeability, and fluid saturations). A dynamic model includes the static model data as well as dynamic fluid parameters and/or rock multiphase flow parameters. The dynamic fluid parameters may include pressure, volume, temperature (PVT) parameters and/or initialization input (e.g., fluid contact depths, pressure, and fluid composition versus depth). The rock multiphase flow parameters may include relative permeability and capillary pressure tables.

The reservoir model may include (or not include) uncertainty framing inputs. The uncertainty framing inputs may define types and/or ranges of parameters in the reservoir model that are uncertain. The parameters may include porosity, permeability, compressibility, relative permeability, other reservoir model input parameters, or a combination thereof.

The method 700 may also include generating and/or simulating different ensembles of dynamic cases of the reservoir model to produce simulated dynamic cases, as at 720. As used herein, an “ensemble” may refer to a number/plurality of simulation cases that differ in their input parameters as a result of uncertainty, but they are similar in modelling scope (e.g., of a particular oilfield) and the development scenario. The dynamic cases may each include one or more levels. In one embodiment, the dynamic cases may include a global level, a regional level, a well level, a completion level, or a combination thereof. The global level may be or include a reservoir-wide parameter such as rock wettability. The regional level may be defined based on structure (e.g., different fault blocks and/or segments) or based on geological interpretation or layering. At the well level, the scope of well-specific parameters may be limited to the vicinity of their assigned wells. At the completion level, the parameters can also be specified for specific completion intervals (e.g., a hydraulic fracturing stage).

The dynamic cases may be generated/simulated while varying one or more of the parameters (e.g., porosity, permeability, compressibility, relative permeability). For example, one of the parameters may have a first value in a first of the dynamic cases, and the same parameter may have a second (e.g., different) value in a second of the dynamic cases. The parameters may also or instead be varied on the different levels of the dynamic cases. For example, one of the parameters may have a first value in a first (e.g., global) level of a dynamic case, and the same parameter may have a second (e.g., different) value in a second (e.g., regional) level of the dynamic case.

In one embodiment, varying the parameters may be performed by a direct assignment of the values. In another embodiment, varying the parameters may be performed by applying multipliers to the values, incrementing or decrementing the values, scaling the values, or a combination thereof. In another embodiment, varying the parameters may be performed by applying correlation coefficients to vary constitutive relationships including relative permeability, capillary pressure, hysteresis, compaction tables, hydraulic fracture conductivity/completion degradation with time, transient matrix-fracture shape factors, or a combination thereof. In another embodiment, the parameters may have various distribution factors (e.g., uniform, normal, log-normal, truncated normal, truncated log-normal, or a user specified list) which may be varied.

The parameters may be based on the uncertainty framing inputs or based on several classes of criteria. The parameters may be sensitized inside a geological modeling package and/or through an extensibility of simulation engines. A scope of the parameters may encompass one or more of the steps for building the reservoir model. Varying the parameters may not be limited to dynamic input to the reservoir model. For example, the parameters may be related to the resolution of a geometrical grid in a horizontal direction and/or vertical direction, facies modeling, and 3D parameters modelling inferred by any type of geo-statistical algorithm variogram inputs. The parameters may also or instead be related to trend maps, which may be subject to uncertainty to gain leads on history-matching.

A ML parameter modeling method (e.g., EMBER) may be employed to vary the parameters at one or more of the levels (e.g., at the well level) based on one or more geological trends in the reservoir model. These trends may include geological concepts and/or seismic attributes to guide the parameter population in the areas between wells. The distribution of the parameters at the different levels can be set in a geological modeling platform that generates the reservoir model or through the programming facility/extensibility of the simulation engines.

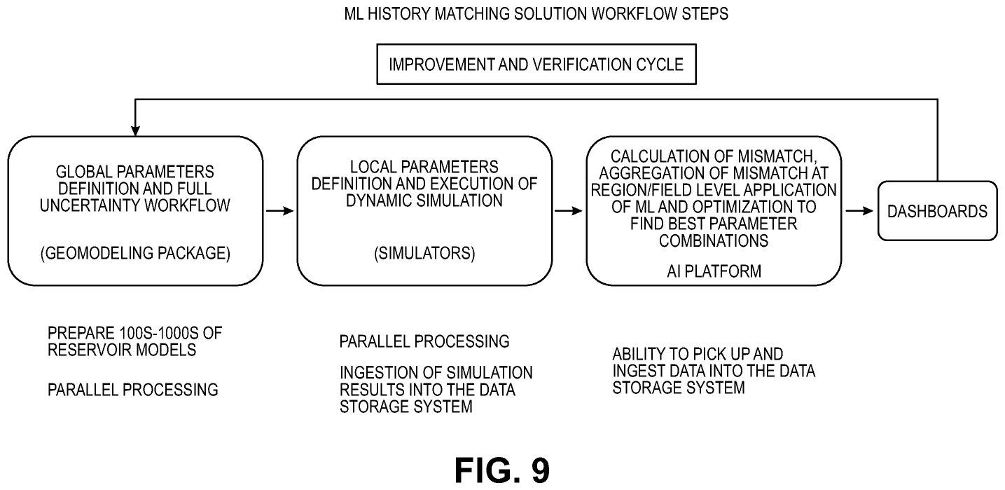

The method 700 may also include performing (e.g., assisted) history matching between the simulated dynamic cases and observed production data, as at 730. An example of this is shown in FIG. 9. The history matching may be performed to identify a combination of the parameters (and/or values of the parameters) that result in a mismatch value being less than a mismatch threshold. The mismatch value is between the simulated dynamic cases and observed (e.g., measured) production data in the field (i.e., in or around the reservoir). The history matching may be performed using proxy modeling or ensemble Kalman filters (EnKF).

### Proxy Modeling

Machine and/or deep learning proxy models may be trained using a subset of the parameters to predict results of the simulated dynamic cases (e.g., single point results where the results of the simulated dynamic cases include the mismatch value between the different ensembles of dynamic cases and the observed production data of the field, or time-series data such as oil production rates). The proxy models may be run on the different levels (global, regional, well, completion).

An optimizer may then run on top of the proxy models to minimize the mismatch value. The optimizer can yield one or more combinations of the parameters leading to minimization of the mismatch value. Hence, one or more sets of the solution can be applied to the reservoir model seeking minimization of the mismatch value. This verification can at least give a certainty about a result of minimizing the mismatch value in any types of scenarios. The solution can be applied for the best technical case or to configuration of cases with higher degree of data input variability for uncertainties quantifications purposes. This approach by the use of the proxy model, in which optimization is considered as a core to seek minimal mismatch, may represent a super-fast technique and cannot be bottlenecked by any type of computer. It also includes a very low computing cost and can be used to determine a history-matching (HM) solution.

### Ensemble Kalman Filters

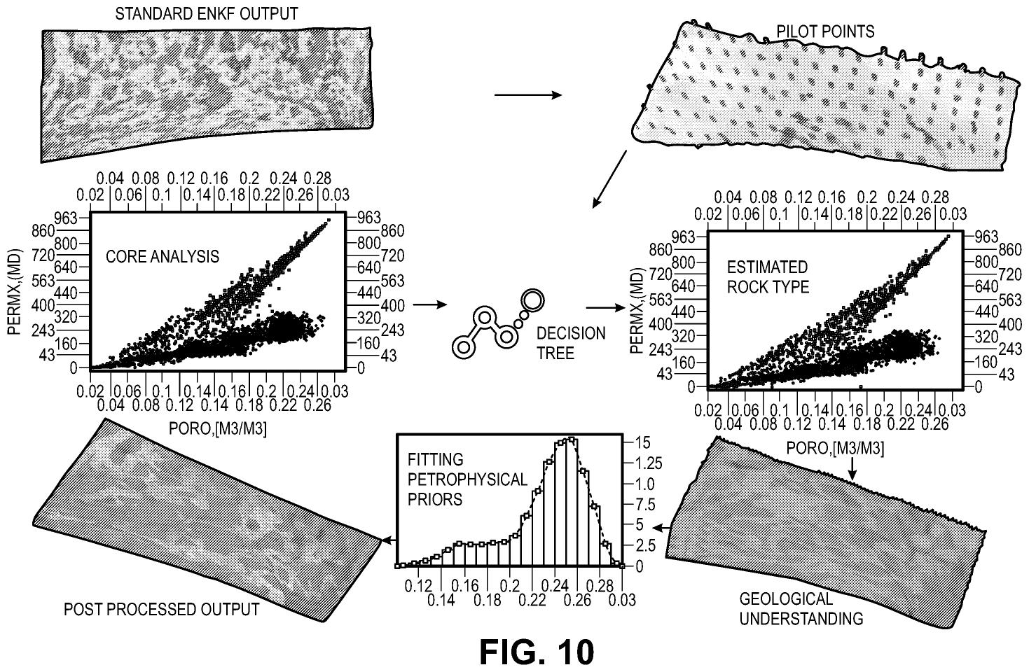

An example of the ensemble Kalman filter post-processing workflow is shown in FIG. 10. A post conditioning method may be implemented to avoid a collapse of the ensemble of dynamic cases and unphysical values assignment based on pilot-points, a ML classification model, and 3D parameters population. As used herein, a “collapse of the ensemble of dynamic cases” refers to a situation where the input parameters become similar in values after the history matching updates. A collapsed ensemble therefore does not reflect the uncertainty in the subsurface. As used herein, an “unphysical values assignment” refers to values of the parameters that are not physically possible. The pilot-points are observation points where the outcome of the ensemble Kalman filters is taken. The parameters observed at the pilot-points may be fed to a ML-based facies classifier. Object-based modeling, sequential indicator simulation, or EMBER® can then be used to populate the grid with facies followed by petrophysical modeling. Known parameters at existing well locations may be honored.

The method 700 may also include generating a display based upon the combination of the parameters that cause the mismatch value to be below the mismatch threshold, as at 740. The display may include a plurality of dashboard components that are generated during and/or after the assisted history matching to help expedite subsequent iterations of the assisted history matching and/or field development decisions.

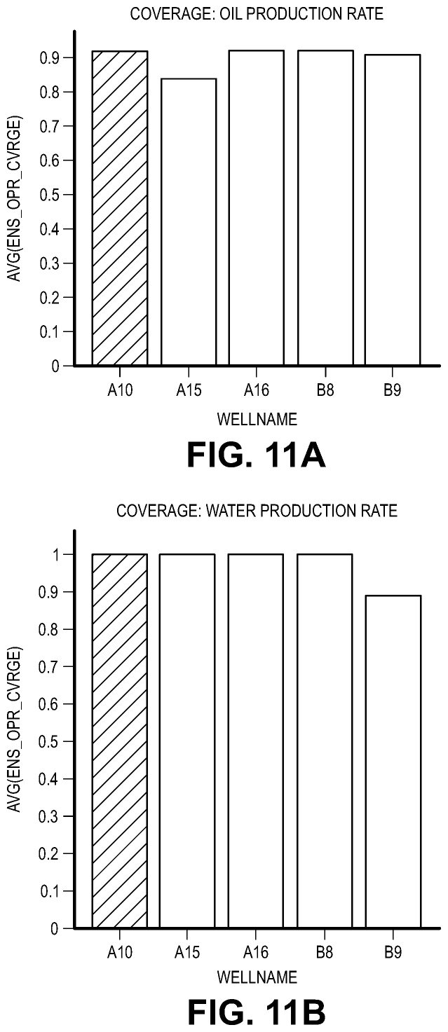

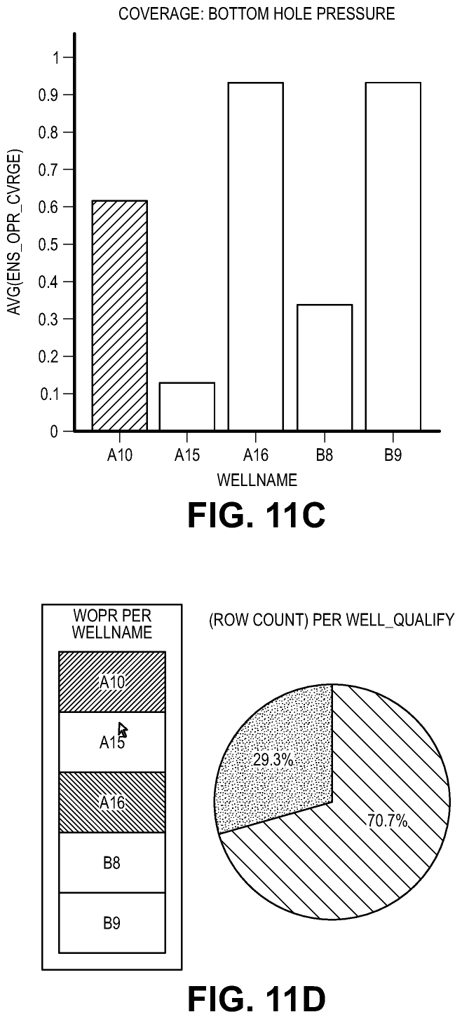

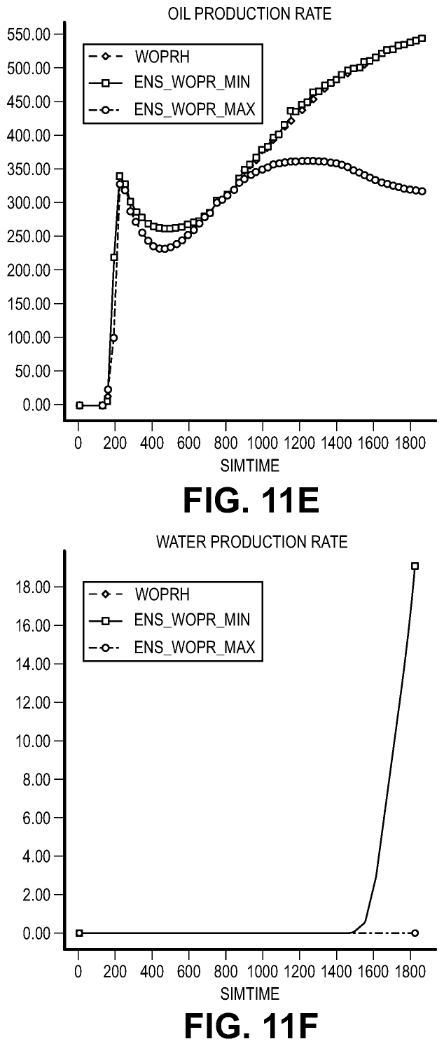

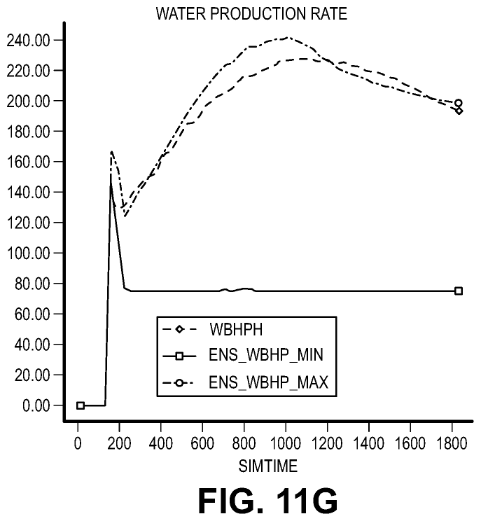

The display (e.g., dashboard components) may include an ensemble coverage analysis. An example of an ensemble coverage analysis is shown in FIGS. 11A-11G. More particularly, FIG. 11A illustrates a graph showing an oil production rate, FIG. 11B illustrates a graph showing a water production rate, FIG. 11C represents a graph showing a bottom-hole pressure, FIG. 11D illustrates a graph showing a well oil production rate, FIG. 11E illustrates another graph of the oil production rate, FIG. 11F illustrates another graph of the water production rate, and FIG. 11G illustrates yet another graph of the water production rate.

For each level (e.g., global, regional, well, completion) of the results the simulated dynamic cases, the ensemble coverage analysis may evaluate whether the observed production data is within (e.g., upper and lower) bounds of the results the simulated dynamic cases. An ensemble coverage parameter may be calculated for each of the levels to reflect how much of the observed production data is within the bounds of the different ensembles of dynamic cases. A value of 0 indicates that observed production data is completely outside of the bounds of the different ensembles of dynamic cases, while a value of 1.0 indicates full coverage.

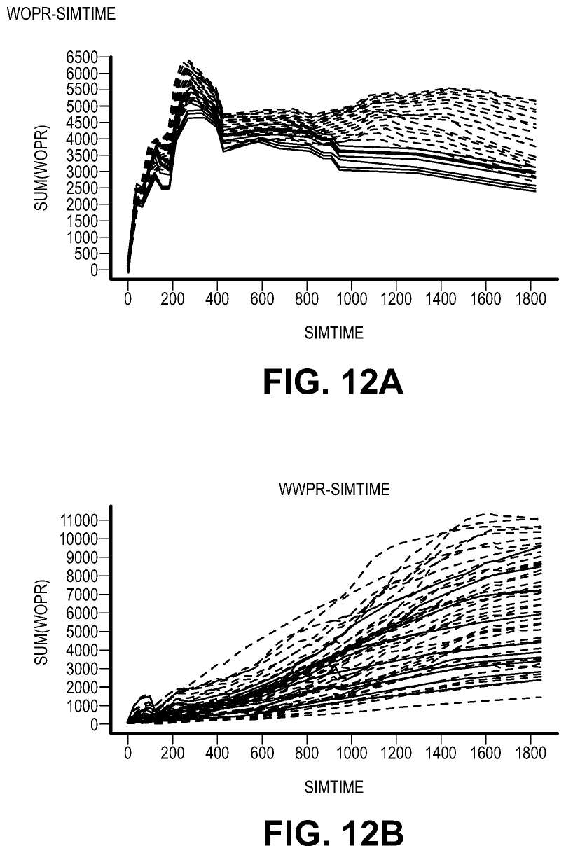

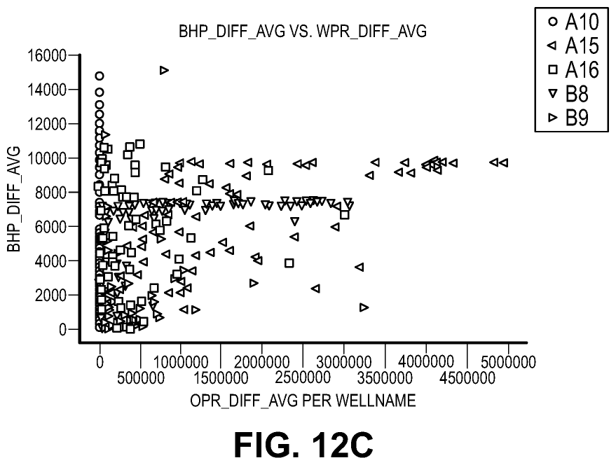

The display (e.g., dashboard components) may also or instead include a mismatch analysis (e.g., on 2D plots). An example of a mismatch analysis on 2D plots (e.g., at the field level) is shown in FIGS. 12A-12D. More particularly, FIG. 12A illustrates a graph showing a sum of the wells' oil production rate SUM(WOPR) plotted against simulation time SIMTIME, FIG. 12B illustrates a graph showing the sum of the wells' water production rate SUM(WWPR). Both plots indicate the matched and unmatched cases (e.g., solid lines versus dotted lines). FIG. 12C illustrates a graph showing the mismatch in bottom hole pressure (BHP_DIFF_AVG) versus the mismatch in oil production rate (OPR_DIFF_AVG). The shape in the scatter plot indicates the well where the mismatch values were taken from. FIG. 12D illustrates a graph showing a mismatch waterfall diagram that provides a quick means to identify offending flow entities that cause the mismatch value(s).

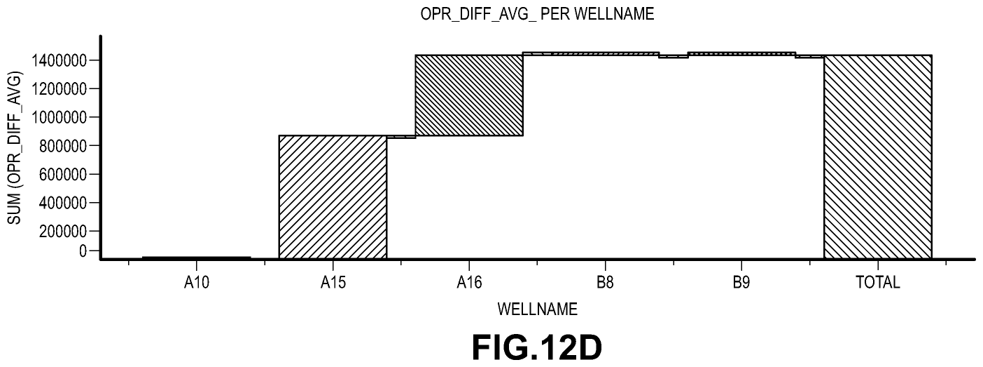

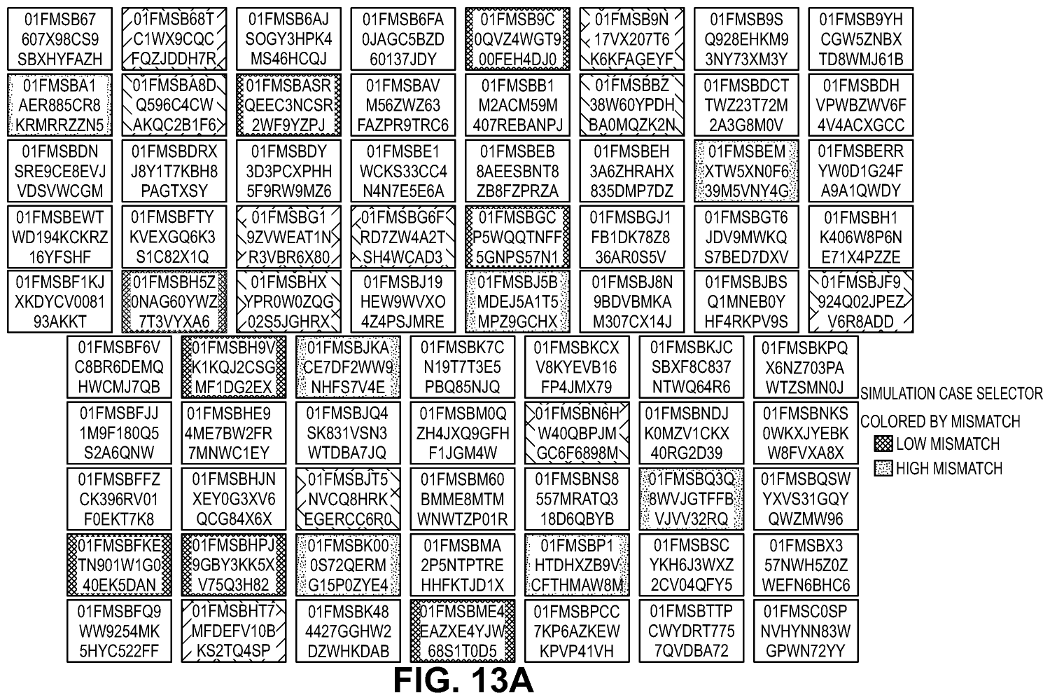

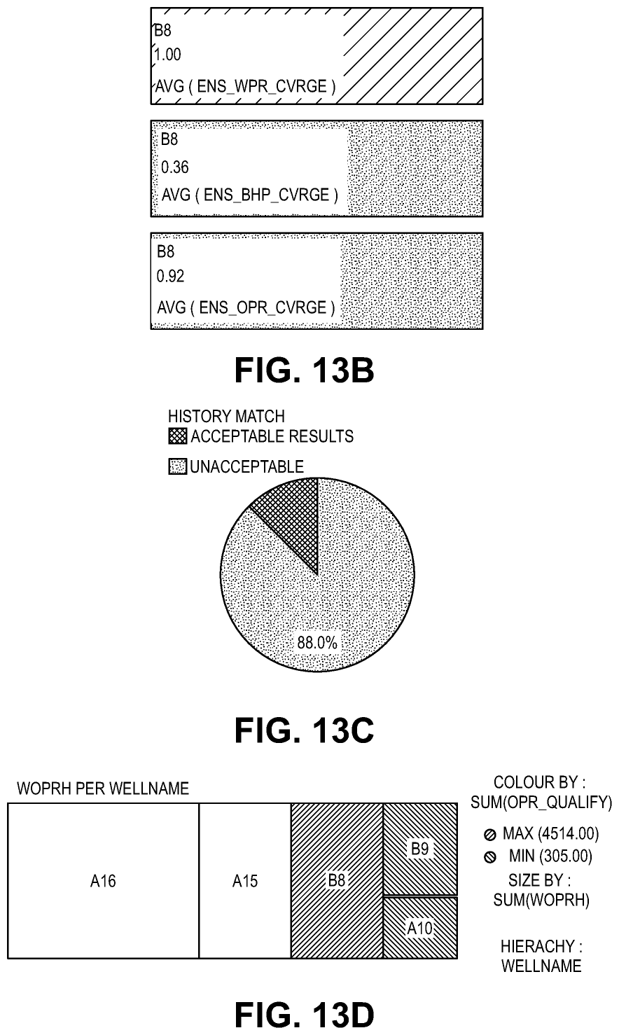

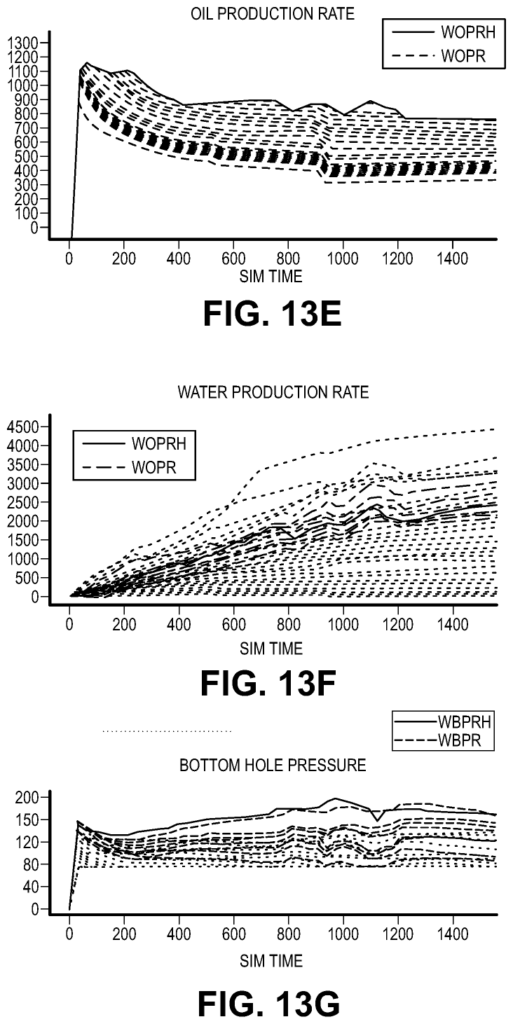

An example of a mismatch analysis on 2D plots (e.g., at the well level) is shown in FIGS. 13A-13G. More particularly, FIG. 13A illustrates a simulation case selector, FIG. 13B illustrates an ensemble coverage per well, FIG. 13C illustrates a history-matching graph, FIG. 13D illustrates a well selector whereby the box size indicate the well importance (for example its total cumulative production, average production rate or well coverage metrics), FIG. 13E illustrates a graph showing an oil production rate, FIG. 13F illustrates a graph showing a water production rate, and FIG. 13G illustrates a graph showing bottom hole pressure. These graphs reflect the user well/simulation case selection.

The mismatch value may be used to color production and/or injection profiles to indicate the number and/or density of the ensembles of dynamic cases with an acceptable match (e.g., a mismatch value less than the mismatch threshold) compared to the others. The contribution of each object and/or simulation results level to the overall mismatch value may be shown on a waterfall plot to identify the most offending flow entities. As used herein, an “offending flow entity” refers to a completion, well, or reservoir region that has observed data for which the mismatch value is high (e.g., above the threshold).

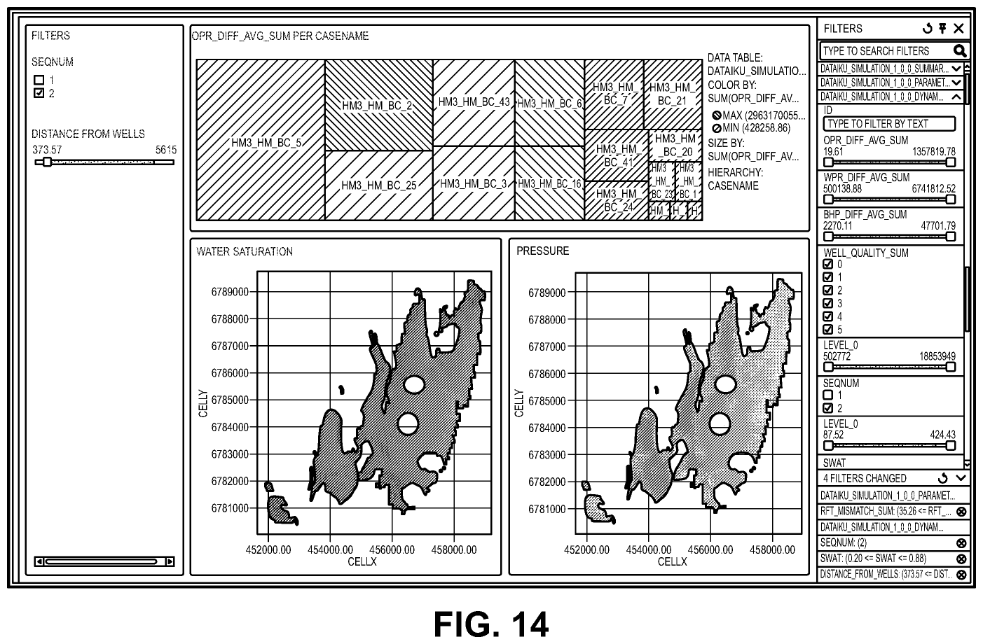

In an embodiment, the parameter distributions can be compared with and without a mismatch filter. The plots can be useful as prior vs posterior uncertainty range analysis. The display (e.g., dashboard components) may also or instead include dynamic grid parameters such as fluid pressure and saturations, which may be displayed across ensembles filtered by the mismatch values. An example of an ensemble level dynamic grid parameters analysis is shown in FIG. 14. More particularly, the top of FIG. 14 illustrates a case selector based on the total mismatch value (e.g., the smaller the box, the smaller the mismatch value), the bottom left image in FIG. 14 illustrates a graph showing water saturation, and the bottom right image in FIG. 14 illustrates a graph showing pressure reflecting the selected cases average/standard deviation.

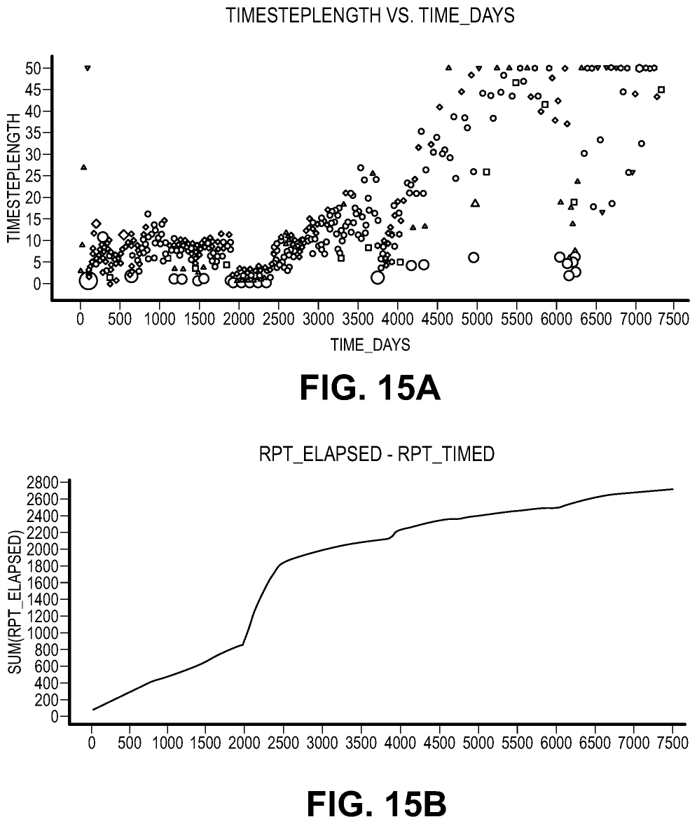

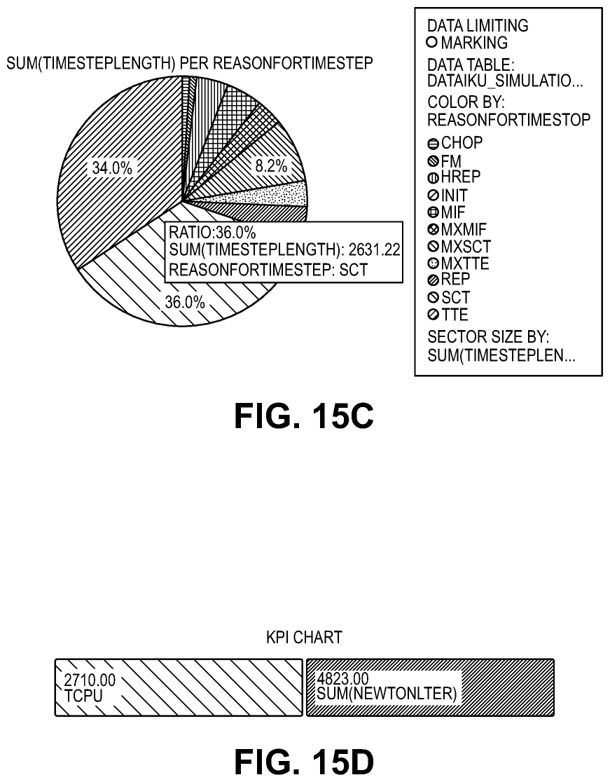

These dynamic grid properties are shown in map views and aggregated across the results of the simulated dynamic cases to assess the level of agreement and/or disagreement in different parts of the reservoir. The larger the standard deviation is in a specific (e.g., field) location, the riskier it may be to drill there. Additional geometrical filters can be added (e.g., distance from existing wells) to help in the infill well location identification. The display (e.g., dashboard components) may also or instead include simulation performance dashboards, which may be created such that numerical simulation performance issues can be diagnosed quickly and reduced to speed-up the history matching process. An example of a performance dashboard (e.g., time-step selection analysis) is shown in FIGS. 15A-15D. More particularly, FIG. 15A illustrates a graph showing the time step length (e.g., of the simulation) versus the actual time (e.g., in days), FIG. 15B illustrates a graph showing the simulation elapsed time (seconds) versus the actual time (days), FIG. 15C illustrates a graph showing a sum of the time steps lengths per reasons for the time steps, and FIG. 15D illustrates a key performance indicator (KPI) chart.

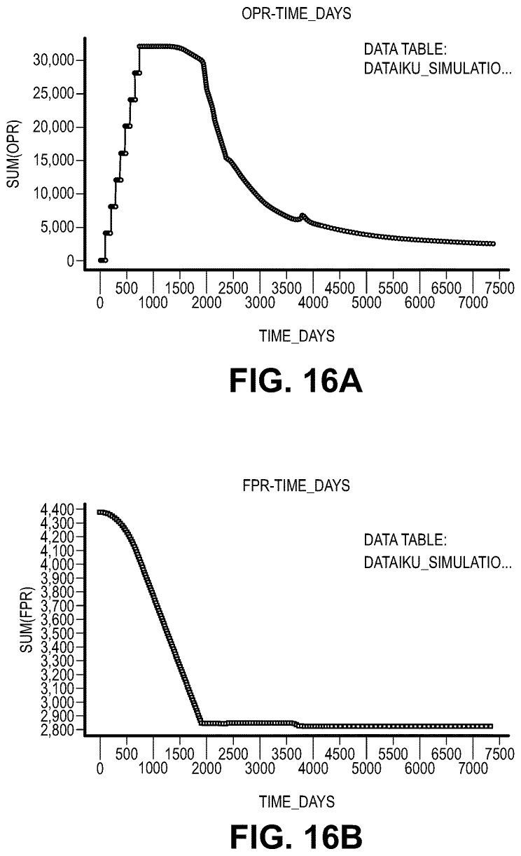

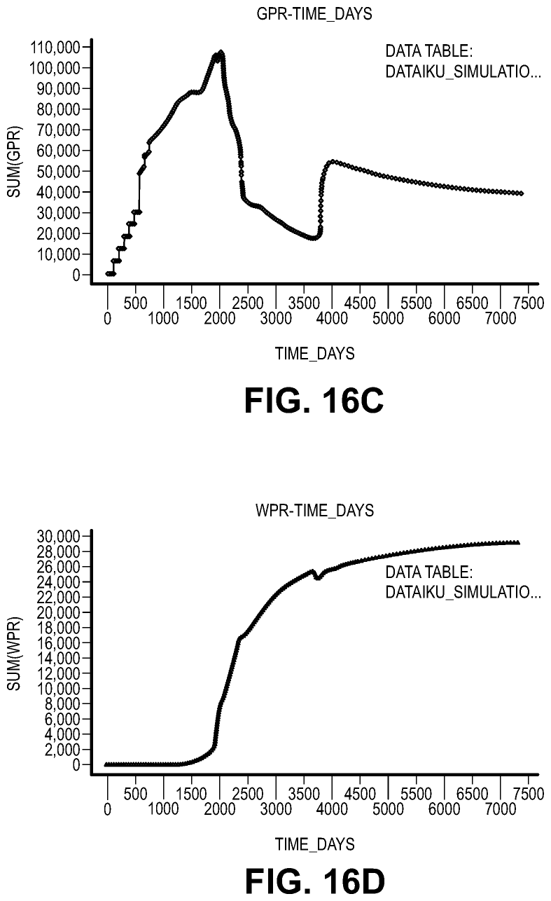

This may include or be based upon a collection of performance metrics from simulation print/log files. The simulation performance dashboards may show or be based upon elapsed time versus simulation time, together with the associated reason for the selection of time-step size (e.g., report step, time-truncation error, solution change error, etc.). The simulation performance dashboards may also show or be based upon field level profiles as read from print/log files. An example of a performance dashboard (e.g., field level profiles collected from log files) is shown in FIGS. 16A-16D. More particularly, FIG. 16A illustrates a graph showing the oil production rate, FIG. 16B illustrates a graph showing the average reservoir pressure, FIG. 16C illustrates a graph showing the gas production rate, and FIG. 16D illustrates a graph showing the water production rate.

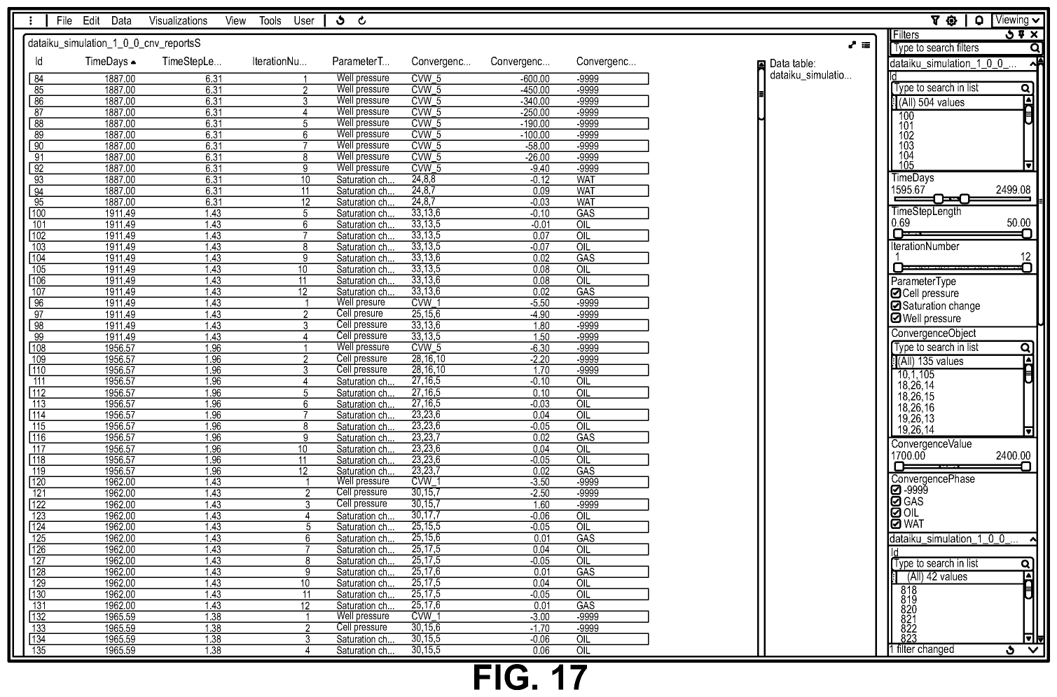

These may be helpful to diagnose a particular period of time (e.g., gas/water injection commence date and the related impacts on simulation performance). The simulation performance dashboards may also show or be based upon detailed non-linear convergence reports citing the cell index and/or the well name causing the non-linear convergence. An example of a performance dashboard (e.g., filterable detailed convergence report) is shown in FIG. 17. A user can quickly find the source of the numerical convergence problems by using the filters using one or more of the following parameters: convergence value, convergence parameter associated phase, and simulation cell identification or well where convergence problems are faced. Identifying the root cause of convergence issues may help to address these issues and therefore speedup the simulation runs and, as a result, the history matching process.

The method 700 may also include performing a wellsite action, as at 750. The wellsite action may be performed based upon the history matching, the parameters that result in the mismatch value being less than the mismatch threshold, the display (e.g., the dashboard components), or a combination thereof. The wellsite action may be or include generating and/or transmitting a signal (e.g., using a computing system) that causes a physical action to occur at a wellsite. The wellsite action may also or instead include performing the physical action at the wellsite. The physical action may be or include selecting where to drill a wellbore, drilling the wellbore, varying a weight and/or torque on a drill bit drilling the wellbore, varying a drilling trajectory of the wellbore, varying a concentration and/or flow rate of a fluid pumped into the wellbore, or the like.

Embodiments of the present disclosure may provide efficiency gains in the history-matching process, and may provide extensibility for integration into various workflows by leveraging sophisticated machine learning and deep learning models. In some examples, methods according to the present disclosure can reduce the overall study time by one third or more based on several studies. Further, embodiments may be deployed to various customers looking to fast-track their dynamic modeling process that can bring efficiency while compromising on the quality of the results.

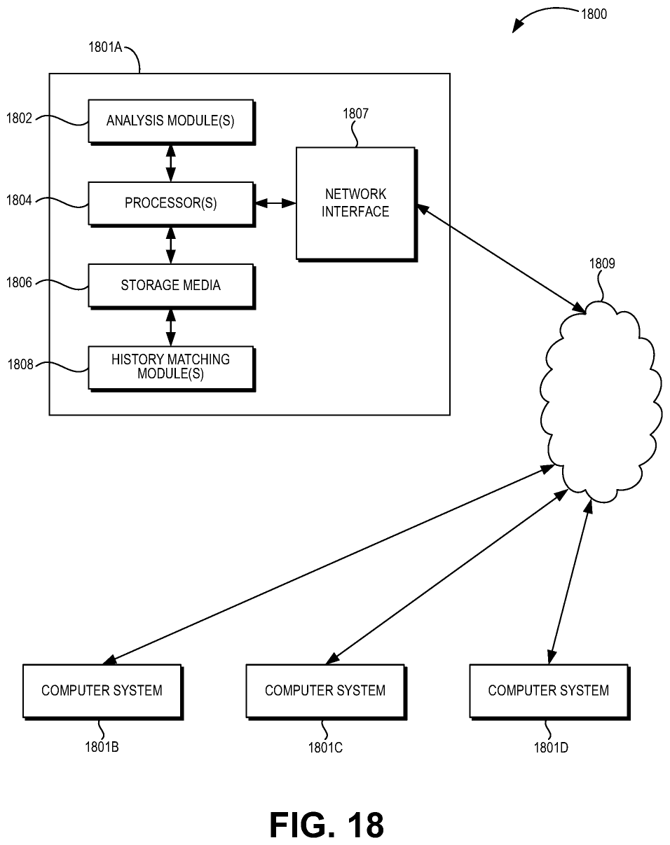

In some embodiments, the methods of the present disclosure may be executed by a computing system. FIG. 18 illustrates an example of such a computing system 1800, in accordance with some embodiments. The computing system 1800 may include a computer or computer system 1801A, which may be an individual computer system 1801A or an arrangement of distributed computer systems. The computer system 1801A includes one or more analysis modules 1802 that are configured to perform various tasks according to some embodiments, such as one or more methods disclosed herein. To perform these various tasks, the analysis module 1802 executes independently, or in coordination with, one or more processors 1804, which is (or are) connected to one or more storage media 1806. The processor(s) 1804 is (or are) also connected to a network interface 1807 to allow the computer system 1801A to communicate over a data network 1809 with one or more additional computer systems and/or computing systems, such as 1801B, 1801C, and/or 1801D (note that computer systems 1801B, 1801C and/or 1801D may or may not share the same architecture as computer system 1801A, and may be located in different physical locations, e.g., computer systems 1801A and 1801B may be located in a processing facility, while in communication with one or more computer systems such as 1801C and/or 1801D that are located in one or more data centers, and/or located in varying countries on different continents).

A processor may include a microprocessor, microcontroller, processor module or subsystem, programmable integrated circuit, programmable gate array, or another control or computing device.

The storage media 1806 may be implemented as one or more computer-readable or machine-readable storage media. Note that while in the example embodiment of FIG. 18 storage media 1806 is depicted as within computer system 1801A, in some embodiments, storage media 1806 may be distributed within and/or across multiple internal and/or external enclosures of computing system 1801A and/or additional computing systems. Storage media 1806 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 1800 contains one or more history matching module(s) 1808 that may perform at least a portion of the method(s) 700 described herein. It should be appreciated that computing system 1800 is merely one example of a computing system, and that computing system 1800 may have more or fewer components than shown, may combine additional components not depicted in the example embodiment of FIG. 18, and/or computing system 1800 may have a different configuration or arrangement of the components depicted in FIG. 18. The various components shown in FIG. 18 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 1800, FIG. 18), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for calibrating a reservoir model, the method comprising:
receiving a reservoir model of a reservoir;
simulating ensembles of dynamic cases of the reservoir model to produce simulated dynamic cases, wherein each dynamic case is different, and wherein the dynamic cases each comprise a plurality of levels;
performing history matching between the simulated dynamic cases and observed production data to identify a combination of parameters of the reservoir model or values of the parameters, wherein the combination of parameters or values of the parameters result in one or more mismatch values between the simulated dynamic cases and the observed production data being less than a mismatch threshold; and
generating a display based upon the combination of the parameters or the values of the parameters that result in the one or more mismatch values being less than the mismatch threshold.

2. The method of claim 1, wherein the reservoir model comprises a static model, a dynamic model, or both.

3. The method of claim 1, wherein the reservoir model comprises uncertainty framing inputs that define types and ranges of the parameters in the reservoir model that are uncertain.

4. The method of claim 1, wherein the levels comprise a global level, a regional level, a well level, and a completion level.

5. The method of claim 1, wherein the dynamic cases are simulated by varying the values of the parameters on each level, by varying the values of the parameters on the levels, or both.

6. The method of claim 1, wherein the history matching is performed using proxy modeling or ensemble Kalman filters.

7. The method of claim 1, wherein the display comprises a plurality of dashboard components that expedite subsequent iterations of the history matching.

8. The method of claim 1, further comprising performing a wellsite action in response to the one or more mismatch values, the combination of the parameters or the values of the parameters, or the display.

9. The method of claim 8, wherein the wellsite action comprises generating or transmitting a signal that causes a physical action to occur at a wellsite that includes the reservoir.

10. The method of claim 9, wherein the physical action comprises drilling a wellbore, varying a weight and/or torque on a drill bit drilling the wellbore, varying a drilling trajectory of the wellbore, or varying a concentration and/or flow rate of a fluid pumped into the wellbore.

11. A computing system, comprising:
one or more processors; and
a memory system comprising one or more non-transitory computer-readable media storing instructions that, when executed by at least one of the one or more processors, cause the computing system to perform operations, the operations comprising:
receiving a reservoir model of a reservoir, wherein the reservoir model comprises a static model, a dynamic model, or both, and wherein the reservoir model comprises uncertainty framing inputs that define types and ranges of parameters in the reservoir model that are uncertain;
simulating ensembles of dynamic cases of the reservoir model to produce simulated dynamic cases, wherein each dynamic case is different, wherein the dynamic cases each comprise a plurality of different levels, wherein the levels comprise a global level, a regional level, a well level, and a completion level, wherein the dynamic cases are simulated by varying values of the parameters on each level, by varying the values of the parameters on the different levels, or both;
performing assisted history matching between the simulated dynamic cases and observed production data to identify a combination of the parameters and the values of the parameters, wherein the combination of the parameters and the values of the parameters result in one or more mismatch values between the simulated dynamic cases and the observed production data being less than a mismatch threshold, and wherein the assisted history matching is performed using proxy modeling or ensemble Kalman filters; and
generating a display based upon the combination of the parameters or the values of the parameters that result in the one or more mismatch values being less than the mismatch threshold, wherein the display comprises a plurality of dashboard components that expedite subsequent iterations of the assisted history matching.

12. The computing system of claim 11, wherein the assisted history matching is performed using the proxy modeling by:
training one or more proxy models using a subset of the parameters to predict the simulated dynamic cases on the different levels; and
determining the combination of the parameters or the values of the parameters to reduce the one or more mismatch values using the one or more proxy models.

13. The computing system of claim 12, wherein training the one or more proxy models predicts a plurality of single point results where the simulated dynamic cases include the one or more mismatch values.

14. The computing system of claim 11, wherein the assisted history matching is performed using the ensemble Kalman filters, and wherein the ensemble Kalman filters are based at least partially upon one or more pilot-points, a machine-learning classification model, and a three-dimensional population of the parameters.

15. The computing system of claim 14, wherein using the ensemble Kalman filters prevents a collapse of the ensemble of dynamic cases and prevents an assignment of unphysical values to the parameters.

16. A non-transitory computer-readable medium storing instructions that, when executed by one or more processors of a computing system, cause the computing system to perform operations, the operations comprising:
receiving a reservoir model of a reservoir that includes:
a static model, and
a dynamic model, wherein the reservoir model comprises uncertainty framing inputs that define types and ranges of parameters in the reservoir model that are uncertain, and
wherein the parameters include:
porosity, permeability, compressibility, and relative permeability;
simulating ensembles of dynamic cases of the reservoir model to produce simulated dynamic cases,
wherein each dynamic case is different,
wherein the dynamic cases each comprise a plurality of different levels,
wherein the levels comprise a global level, a regional level, a well level, and a completion level,
wherein the dynamic cases are simulated by varying values of the parameters on each level such that a first of the parameters has a first value in a first of the dynamic cases on a first of the levels, and the first parameter has a second value in a second of the dynamic cases on the first level,
wherein the first and second values are different,
wherein the dynamic cases are also simulated by varying the values of the parameters on the different levels such that the first parameter has a third value in a third of the dynamic cases on the first level, and the first parameter has a fourth value in a fourth of the dynamic cases on a second one of the levels, and
wherein the third and fourth values are different;
performing assisted history matching between the simulated dynamic cases and observed production data to identify a combination of the parameters and the values of the parameters,
wherein the combination of the parameters and the values of the parameters result in one or more mismatch values between the simulated dynamic cases and the observed production data being less than a mismatch threshold, and
wherein the assisted history matching is performed using proxy modeling or ensemble Kalman filters;
generating a display based upon the combination of the parameters or the values of the parameters that result in the one or more mismatch values being less than the mismatch threshold,
wherein the display comprises a plurality of dashboard components that expedite subsequent iterations of the assisted history matching; and
performing a wellsite action in response to the one or more mismatch values, the combination of the parameters or the values of the parameters, or the dashboard components,
wherein the wellsite action comprises generating or transmitting a signal that causes a physical action to occur at a wellsite.

17. The medium of claim 16, wherein the dashboard components comprise an ensemble coverage analysis that evaluates whether the observed production data is within upper and lower bounds of the simulated dynamic cases on each of the different levels.

18. The medium of claim 16, wherein the dashboard components comprise a mismatch analysis that indicates a number or density of the simulated dynamic cases where the one or more mismatch values are less than the mismatch threshold, and wherein the mismatch analysis comprises a different two-dimensional plot for each of the different levels.

19. The medium of claim 16, wherein the dashboard components comprise dynamic grid parameters that are based upon the simulated dynamic cases and shown in one or more maps, wherein the dynamic grid parameters comprise fluid pressure, fluid saturation, or both, wherein standard deviations of the dynamic grid parameters are determined in a plurality of different locations on the one or more maps, and wherein a larger standard deviation indicates an increased risk in response to drilling in a particular one of the locations.

20. The medium of claim 16, wherein the dashboard components comprise simulation performance dashboards to diagnose numerical simulation performance issues encountered when simulating the ensembles of dynamic cases and to increase a speed of the subsequent iterations of the assisted history matching, wherein the simulation performance dashboards are based at least partially upon actual elapsed time versus time taken to simulate the ensembles of dynamic cases.
